(19) United States
(12) Patent Application Publication
(10) Pub. No.: US 2026/0066208 A1
(43) Pub. Date: Mar. 5, 2026

(54) REUSABLE FUSE

(71) Applicant: Chun-Cheng Lin, TAOYUAN CITY (TW)

(72) Inventor: Chun-Cheng Lin, TAOYUAN CITY (TW)

(21) Appl. No.: 18/823,676

(22) Filed: Sep. 3, 2024

(51) Int. Cl. H01H 85/20; H01H 85/06

(52) U.S. Cl. CPC H01H 85/2015; H01H 85/06

(57) ABSTRACT

A reusable fuse includes a housing with a first opening and a second opening. A first prong includes a first insertion part and a fuse element. The fuse element has a first contact point. The first insertion part is located corresponding to the first opening. A second prong includes a second insertion part formed to a first end of the second prong. A second contact point is located on a side of a second end of the second prong. The second insertion part is located corresponding to the second opening. The fuse element, the first insertion part, and the second prong are made of metal. A coefficient of thermal expansion of the fuse element is different from a coefficient of thermal expansion of each of the first insertion part and the second prong. The first contact point contacts the second contact point normally.

### FIELD OF THE INVENTION

The present invention relates to a reusable fuse, suitable for automotive fuse sockets, which provides circuit protection in the event of a short circuit and can be reset for repeated use without the need for disposal after the abnormal condition is resolved.

### BACKGROUND OF THE INVENTION

With the advancement of technology, electricity has become integrated into a wide range of everyday devices, such as automobiles, which are equipped with various circuits. However, when an abnormal error occurs in the circuit system, a short circuit may result, potentially leading to the destruction of all associated circuits and electronic components. Therefore, it is necessary to install fuses throughout the circuits to cut off the power immediately when a short circuit occurs, thereby reducing the impact on the circuit system during such anomalies.

The type of fuse commonly used in automobiles, as shown in Taiwan Patent No. M496218, is a “plug-in fuse with a melting indication.” According to this patent, it is known that this type of fuse has an internal metal that melts during a short circuit, resulting in a break in the circuit. This type of fuse is widely used in all vehicles today. However, it has a drawback: once it melts, it must be removed and discarded, and a new fuse must be inserted into the fuse socket. Additionally, because of the limited internal space in automobiles, circuits are often hidden in very narrow and crowded areas, making it difficult for maintenance personnel to replace the fuse.

As mentioned above, it is evident that current automotive fuses must be replaced every time a short circuit occurs, which undoubtedly causes inconvenience for maintenance personnel and generates more waste. Therefore, whether from an environmental perspective or for the convenience of maintenance personnel, this issue needs to be addressed and improved.

The present invention intends to provide a reusable fuse to eliminate the shortcomings mentioned above.

To address the issues with conventional designs, the present invention introduces improvements to the structure of the first and second prongs. The first prong is composed of metal materials with different coefficients of thermal expansion. These materials form the first insertion part and a fuse element. The second prong is made entirely of the same metal as the first insertion part. For instance, the fuse element is made of copper, while the second prong and the first insertion part are made of iron.

In normal conditions, the first contact point on the fuse element touches the second contact point on the second prong, allowing the circuit to conduct. However, when a short circuit occurs in the corresponding circuit, the high temperature generated by the instantaneous large current causes the fuse element to bend outward, leading to the separation of the first and second contact points and forming a break in the circuit. As the temperature gradually decreases over time, the fuse element slowly returns to its normal state, causing the first contact point to touch the second contact point again, completing the reset.

From the above description, it is clear that the present invention does not require disposal after a circuit break like traditional fuses. Instead, it can be reset and reused. Compared to traditional products, the present invention indeed offers novelty and progress.

### SUMMARY OF THE INVENTION

The present invention relates to a reusable fuse and comprises a housing with a first opening and a second opening on one side thereof. A first prong is positioned inside the housing and includes a first insertion part and a fuse element. The fuse element has a first contact point on one side thereof. The first insertion part is located corresponding to the first opening.

A second prong is positioned inside the housing and includes a second insertion part formed to a first end of the second prong. A second contact point is located on a side of a second end of the second prong. The second insertion part is located corresponding to the second opening. The fuse element, the first insertion part, and the second prong are made of metal. A coefficient of thermal expansion of the fuse element is different from a coefficient of thermal expansion of each of the first insertion part and the second prong. The first contact point contacts the second contact point normally.

Preferably, a portion of the first insertion part facing the first opening includes two first arms. A portion of the second insertion part facing the second opening includes two second arms.

Preferably, each of the two first arms has multiple first raised portions formed on an inside thereof. The multiple first raised portions face each other. Each of the two second arms has multiple second raised portions formed on an inside thereof. The multiple second raised portions face each other.

Preferably, the housing includes a first part and a second part. The first part and the second part are connected to each other to form an accommodating space in the housing, the first prong and the second prong are located within this accommodating space.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view of the present invention;

FIG. 2 is an exploded view of the present invention;

FIG. 3 is another exploded view of the present invention from a different angle;

FIG. 4 is a diagram showing the present invention before assembly with the fuse socket;

FIG. 5 is a diagram showing the present invention after assembly with the fuse socket;

FIG. 6 is a cross-sectional view, taken along line VI-VI in FIG. 5;

FIG. 7 is a cross-sectional view, taken along line VII-VII in FIG. 5, and

FIG. 8 is a diagram showing the fuse element bending outward during a short circuit.

### DETAILED DESCRIPTION OF THE PREFERRED EMBODIMENT

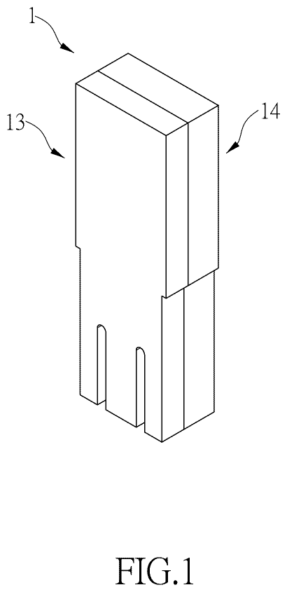

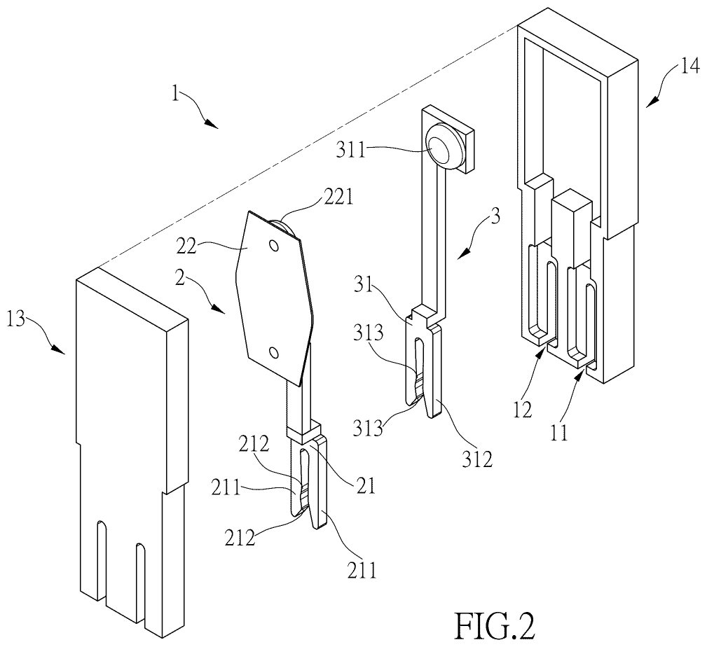

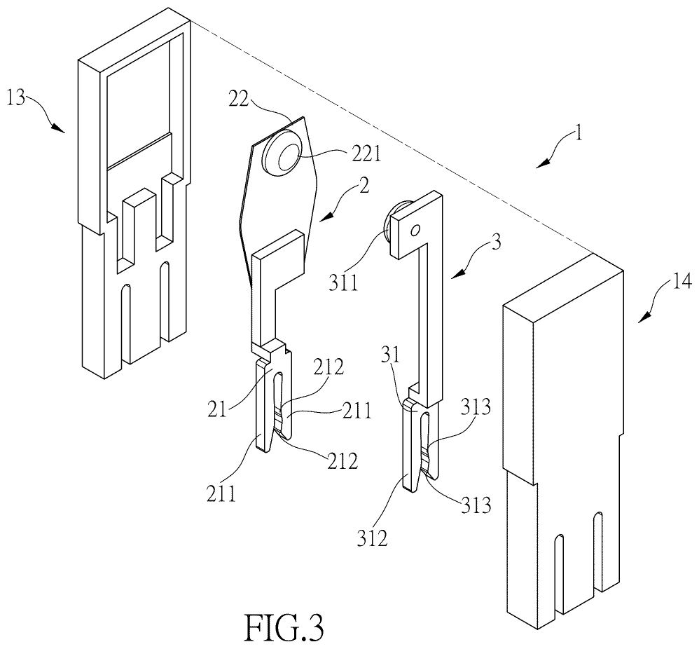

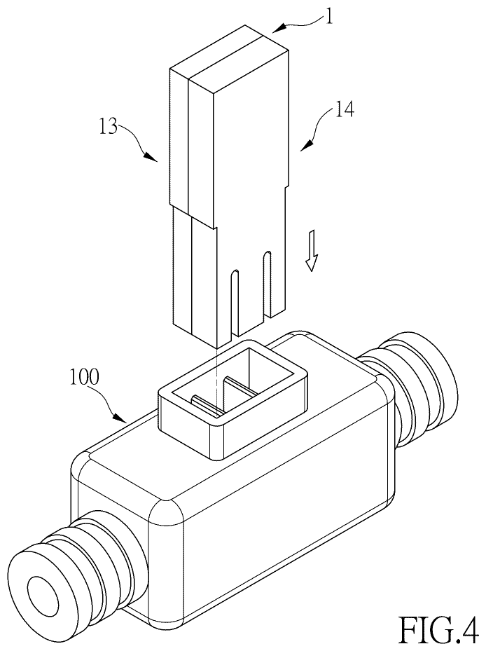

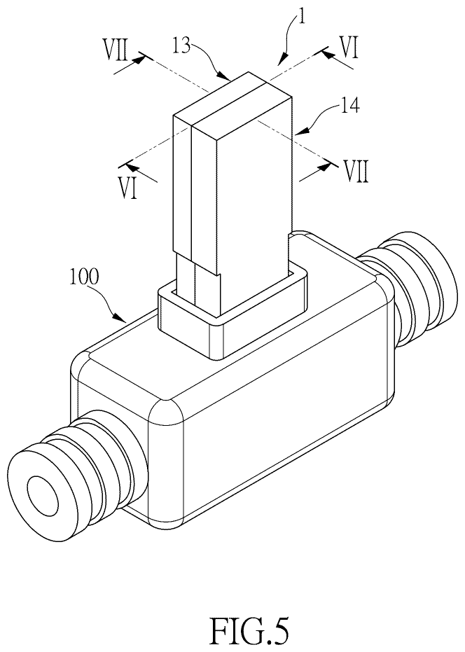

Referring to FIGS. 1 to 6, the reusable fuse of the present invention comprises a housing (1) with a first opening (11) and a second opening (12) on one side thereof. A first prong (2) is positioned inside the housing (1) and includes a first insertion part (21) and a fuse element (22). The fuse element (22) has a first contact point (221) on one side thereof. The first insertion part (21) is located corresponding to the first opening (11). A second prong (3) is positioned inside the housing (1) and includes a second insertion part (31) formed to a first end of the second prong (3). A second contact point (311) is located on a side of a second end of the second prong (3). The second insertion part (31) is located corresponding to the second opening (12). The fuse element (22), the first insertion part (21), and the second prong (3) are made of metal. A coefficient of thermal expansion of the fuse element (22) is different from a coefficient of thermal expansion of each of the first insertion part (21) and the second prong (3). The first contact point (221) contacts the second contact point (311) normally.

To address the issues with conventional designs, the present invention introduces improvements to the structure of the first prong (2) and the second prong (3). The first prong (2) is made of metal materials with different coefficients of thermal expansion, specifically the first insertion part (21) and the fuse element (22). The second prong (3) is made entirely of the same metal as the first insertion part (21). For example, the fuse element (22) is made of copper, while the second prong (3) and the first insertion part (21) are made of iron.

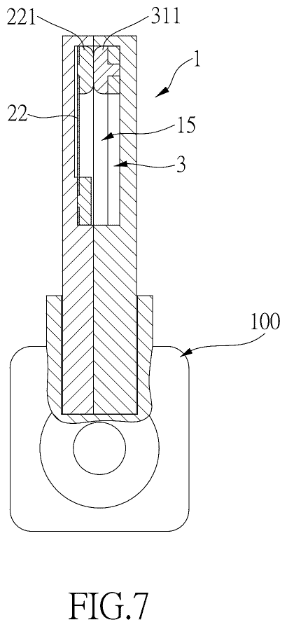

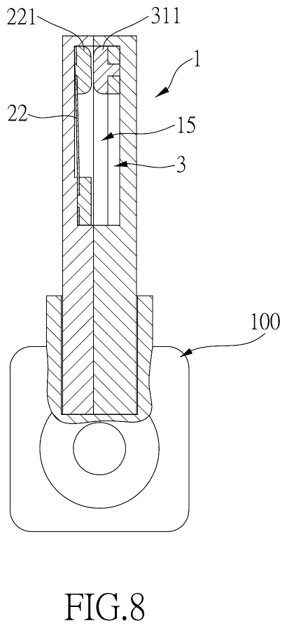

In normal conditions, the first contact point (221) of the fuse element (22) and the second contact point (311) of the second prong (3) are in contact with each other and conduct electricity, as shown in FIG. 7. However, when a short circuit occurs in the corresponding circuit, the high temperature generated by the instantaneous large current causes the fuse element (22) to bend outward, leading to the separation of the first contact point (221) and the second contact point (311), forming a break in the circuit, as shown in FIG. 8. As time passes and the temperature gradually decreases, the fuse element (22) slowly returns to its normal state, allowing the first contact point (221) to touch the second contact point (311) again, completing the reset.

From the above description, it is evident that the present invention does not require disposal after a circuit break like traditional fuses. Instead, it can be reset and reused. Compared to traditional products, the present invention indeed offers novelty and progress.

A portion of the first insertion part (21) facing the first opening (11) includes two first arms (211). A portion of the second insertion part (31) facing the second opening (12) includes two second arms (312). Each of the two first arms (211) has multiple first raised portions (212) formed on an inside thereof. The multiple first raised portions (212) face each other. Each of the two second arms (312) has multiple second raised portions (313) formed on an inside thereof. The multiple second raised portions (313) face each other.

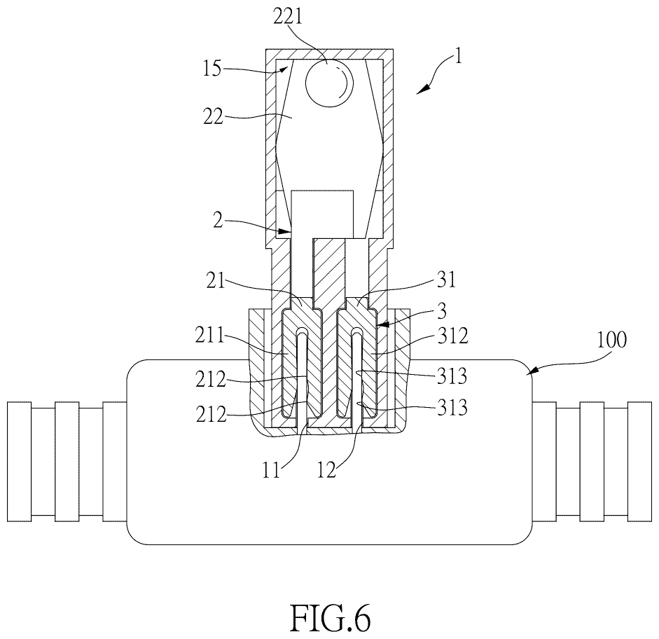

The advantages of the aforementioned structure can be clearly seen in FIG. 6. The first raised portions (212) and the second raised portions (313) allow the first insertion part (21) and the second insertion part (31) to be more securely fixed in a fuse socket (100), reducing the likelihood of them coming loose due to vibrations during vehicle operation.

In addition, the housing (1) includes a first part (13) and a second part (14). The first part (13) and the second part (14) are connected to each other to form an accommodating space (15) therebetween. The first prong (2) and the second prong (3) are located within the accommodating space (15).

While we have shown and described the embodiment in accordance with the present invention, it should be clear to those skilled in the art that further embodiments may be made without departing from the scope of the present invention.

What is claimed is:

1. A reusable fuse comprising:
a housing (1) with a first opening (11) and a second opening (12) on one side thereof;
a first prong (2) positioned inside the housing (1) and including a first insertion part (21) and a fuse element (22), the fuse element (22) having a first contact point (221) on one side thereof, the first insertion part (21) located corresponding to the first opening (11);
a second prong (3) positioned inside the housing (1) and including a second insertion part (31) formed to a first end of the second prong (3), a second contact point (311) located on a side of a second end of the second prong (3), the second insertion part (31) located corresponding to the second opening (12);
wherein the fuse element (22), the first insertion part (21), and the second prong (3) are made of metal, a coefficient of thermal expansion of the fuse element (22) is different from a coefficient of thermal expansion of each of the first insertion part (21) and the second prong (3), the first contact point (221) contacts the second contact point (311) normally.

2. The reusable fuse as claimed in claim 1, wherein a portion of the first insertion part (21) facing the first opening (11) includes two first arms (211), a portion of the second insertion part (31) facing the second opening (12) includes two second arms (312).

3. The reusable fuse as claimed in claim 2, wherein each of the two first arms (211) has multiple first raised portions (212) formed on an inside thereof, the multiple first raised portions (212) face each other, each of the two second arms (312) has multiple second raised portions (313) formed on an inside thereof, the multiple second raised portions (313) face each other.

4. The reusable fuse as claimed in claim 1, wherein the housing (1) includes a first part (13) and a second part (14), the first part (13) and the second part (14) are connected to each other to form an accommodating space (15) therebetween, the first prong (2) and the second prong (3) are located within the accommodating space (15).
